(19) United States
(12) Patent Application Publication
(10) Pub. No.: US 2014/0254001 A1
(43) Pub. Date: Sep. 11, 2014

(54) FABRY-PEROT THIN ABSORBER FOR EUV RETICLE AND A METHOD OF MAKING

(71) Applicants: Lei SUN, Albany, NY (US); Obert Reeves Wood, II, Loudonville, NY (US)

(72) Inventors: Lei SUN, Albany, NY (US); Obert Reeves Wood, II, Loudonville, NY (US)

(73) Assignee: GLOBALFOUNDRIES Inc., Grand Cayman (KY)

(21) Appl. No.: 13/788,315

(22) Filed: Mar. 7, 2013

(51) Int. Cl. G02B 5/28

(52) U.S. Cl. CPC G02B 5/283
USPC 359/360; 216/24

(57) ABSTRACT

A Fabry-Perot thin absorber for an extreme ultraviolet (EUV) reticle and a method of making is disclosed. Embodiments include forming a molybdenum/silicon (Mo/Si) multilayer on an upper surface of a substrate; forming a ruthenium (Ru) capping layer over the Mo/Si multilayer; forming an absorber cavity layer over the Ru layer; forming two or more pairs of a silicon (Si) layer and an absorbing layer over the absorber cavity layer; and etching the Si layers, absorbing layers, and the absorber cavity layer to form a stack.

### TECHNICAL FIELD

The present disclosure relates to absorbers in extreme ultra violet (EUV) reflective reticles. The present disclosure is particularly applicable to 20 nanometer (nm), 14 nm, and beyond semiconductor device technology nodes.

### BACKGROUND

EUV lithography (EUVL) is a next-generation lithography technology for 1×nm technology nodes. A reflective mask (or reticle) is used in a single-exposure process to produce imaged features on a wafer. FIG. 1 illustrates a EUVL reticle 100, according to a conventional design. A reflective multilayer stack 101 on a substrate 103 reflects EUV radiation at unmasked portions by Bragg interference. Masked (non-reflective) areas 105 of reticle 100 are formed by etching buffer layer 107 and absorbing layer 109. Capping layer 111 is formed over the reflective multilayer stack 101 and protects it during the etching. The thickness of absorbing layer 109 ranges from 51 to 77 nm, which may be obtained from the commercial market.

FIG. 2A illustrates a conventional EUVL single-exposure process and a corresponding mask shadowing effect. EUV reticle 200 is irradiated by incident EUV 201 via non-telecentric optics (not shown for illustrative convenience) and is reflected only at unmasked portions of reflective multilayer 203 to produce imaging radiation 205. Due to the non-telecentric optics, incident EUV 201 is at offset angle 207 (conventionally set to six degrees) to a Z-axis normal. Mask shadowing effect 209 is induced by the interaction of the off-axis illumination with the mask topography.

Adverting to FIG. 2B, mask shadowing effect 209 varies depending on the orientation of the mask features with respect to incident EUV 201. Specifically, the imaged features on an exposed wafer indicate a printing difference between the horizontally oriented (H) features 211 and the vertically oriented (V) features 213 (H−V print difference) of EUV reticle 200 (orientation is with respect to the plane formed by incident EUV 201 and plane normal Z; this plane is parallel to the vertical features and perpendicular to the horizontal features). The H−V print difference becomes even greater if either offset angle 207 or the thickness of absorber layers 215 increases.

With the absorber thickness commercially available today, it is possible to compensate the H−V print difference for 1×nm technology nodes, but it does not scale well to smaller critical dimensions, especially for half-pitch values below 25 nm. Neither simple rule-based optical proximity correction (OPC) techniques nor using a thinner absorber layer maintains the printability and defectivity at beyond 1×nm technology nodes. In particular, it is difficult to compensate for the larger H−V print difference using simple rule-based OPC, and absorber layer 109 cannot be made arbitrarily thin without engendering reduced image contrast, process window, normalized image log-slope (NILS), and increased defectivity (e.g., pinholes) caused by increased residual light reflected by multilayer 101 at masked portions.

A need therefore exists for methodology enabling EUV lithography for beyond 1×nm technology nodes while enhancing printability and improving defectivity, and the resulting device.

### SUMMARY

An aspect of the present disclosure is a method for fabricating a Fabry-Perot thin absorber exhibiting enhanced printability and low defectivity.

Another aspect of the present disclosure is a Fabry-Perot thin absorber exhibiting enhanced printability and low defectivity.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

According to the present disclosure, some technical effects may be achieved in part by a method including: forming a molybdenum/silicon (Mo/Si) multilayer on an upper surface of a substrate, forming a ruthenium (Ru) layer over the Mo/Si multilayer, forming an absorber cavity layer over the Ru layer, forming two or more pairs of a silicon (Si) layer and an absorbing layer over the absorber cavity layer, and etching the Si layers, absorbing layers, and the absorber cavity layer to form a stack.

Aspects of the present disclosure include forming the stack to a height above the capping layer of 10 nanometer (nm) to 60 nm. Further aspects include forming the absorber cavity layer and each absorbing layer of Ru. Other aspects include forming each absorbing layer to a thickness of 3 nm to 5 nm, and forming each Si layer to a thickness of 2 nm to 3 nm. Another aspect includes forming the absorber cavity layer to a thickness of 2 nm to 50 nm. Other aspects include forming the absorber cavity layer and each absorbing layer of tantalum nitride (TaN). Additional aspects include forming each absorbing layer to a thickness of 3 nm to 5 nm, and forming each Si layer to a thickness of 2 nm to 3 nm. Another aspect includes forming the absorber cavity layer to a thickness of 2 nm to 50 nm. A further aspect includes forming the Ru layer to a thickness of 2 nm to 5 nm.

Another aspect of the present disclosure is a device including a Mo/Si multilayer on an upper surface of a substrate, a Ru layer over the Mo/Si multilayer, and a stack of an absorber cavity layer and two or more pairs of a Si layer and an absorbing layer formed on the Ru layer.

Aspects include the stack having a height of 10 nm to 60 nm above the Ru layer. Another aspect includes the absorber cavity layer and each absorbing layer including Ru. Further aspects include each absorbing layer being formed to a thickness of 3 nm to 5 nm, and each Si layer being formed to a thickness of 2 nm to 3 nm. An additional aspect includes and the absorber cavity layer being formed to a thickness of 2 nm to 50 nm. Further aspects include the absorber cavity layer and each absorbing layer including TaN. Other aspects include each absorbing layer being formed to a thickness of 3 nm to 5 nm, and each Si layer being formed to a thickness of 2 nm to 3 nm. Another aspect includes the absorber cavity layer being formed to a thickness of 2 nm to 50 nm. An additional aspect includes the Ru layer being formed to a thickness of 2 nm to 5 nm.

Another aspect of the present disclosure is a method including forming a Mo/Si multilayer on an upper surface of a substrate, forming a Ru layer to a thickness of 2 nm to 5 nm over the Mo/Si multilayer, and forming a stack having a thickness of 10 nm to 60 nm on the Ru layer by forming an absorber cavity layer of Ru or TaN to a thickness of 2 nm to 50 nm over the Ru layer, forming a Si layer over the absorber cavity layer forming an absorbing layer of Ru if the absorber cavity layer is formed of Ru or of TaN if the absorber cavity layer is formed of TaN, forming one to nine additional pairs of a Si layer and an absorbing layer over the absorbing layer, and etching the Si layers, the absorbing layers, and the absorber cavity layer. Other aspects include forming each absorbing layer to a thickness of 3 nm to 5 nm, and forming each Si layer to a thickness of 2 nm to 3 nm.

Additional aspects and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 schematically illustrates a background art EUV reticle employing a conventional absorber;

FIGS. 2A and 2B schematically illustrate a shadow masking effect observed with a background art EUV reticle employing a conventional absorber;

FIGS. 3A through 3D schematically illustrate a process flow for forming a EUV reticle employing a Fabry-Perot thin absorber, in accordance with an exemplary embodiment of the present disclosure; and

FIG. 4 schematically illustrates a configuration of a EUV reticle employing a Fabry-Perot thin absorber, in accordance with an exemplary embodiment of the present disclosure.

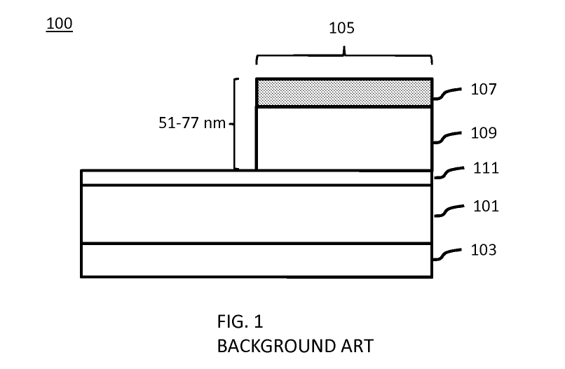

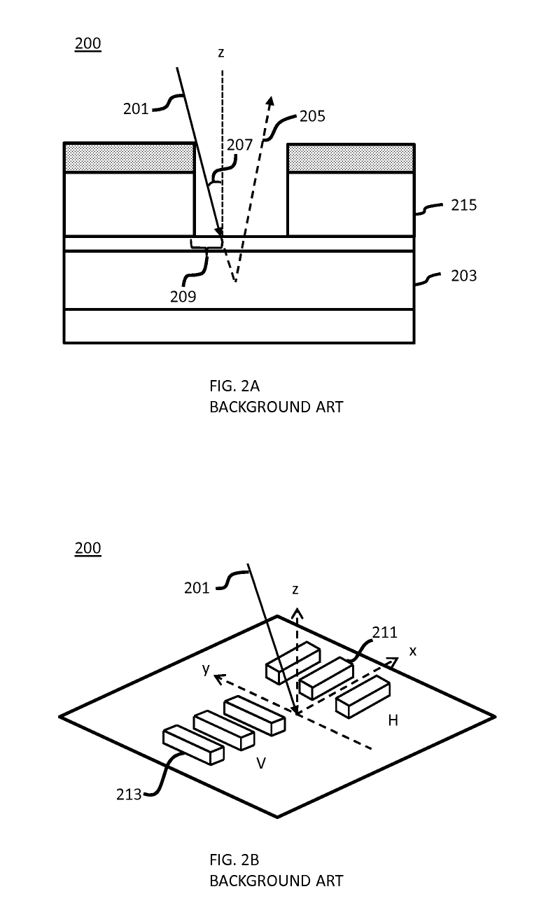

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves the current problem of H−V print difference attendant upon EUV lithography beyond 1×nm technology nodes. In accordance with embodiments of the present disclosure, a Fabry-Perot thin absorber is utilized to reduce H−V print difference and improve printability for beyond 1×nm technology nodes.

A Fabry-Perot thin absorber is proposed to minimize residual reflection from masked portions of a EUV reticle. The thin absorber employs resonance to increase absorption of EUV radiation in the masked portions. A Fabry-Perot cavity is utilized to induce resonance. Transmission (Tₑ) in a Fabry-Perot cavity is a function of the mirror reflection coefficients r₁ and r₂: Tₑ=(1−R²)/(1+R²−2·R·cos(δ/2)), where R=(r₁·r₂), and δ is the phase shift which is function of cavity material and length. Energy conservation requires that the sum of transmission, reflection, and loss coefficients is equal to one. Therefore, reflection within the cavity may be minimized by increasing the relative amount of transmission and loss.

Methodology in accordance with embodiments of the present disclosure includes utilization of an absorber cavity layer to form a Fabry-Perot cavity in the masked portions of a EUV reticle. Additional aspects include a stack of one or more absorber layers interleaved with a resonating layer formed on the absorber cavity layer.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

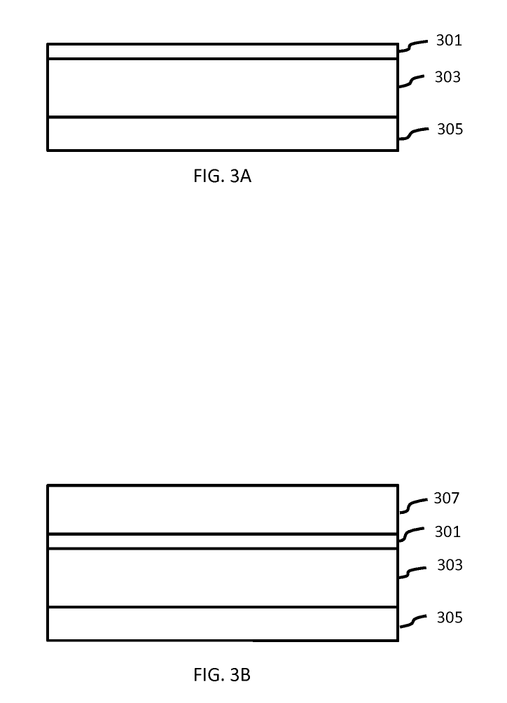

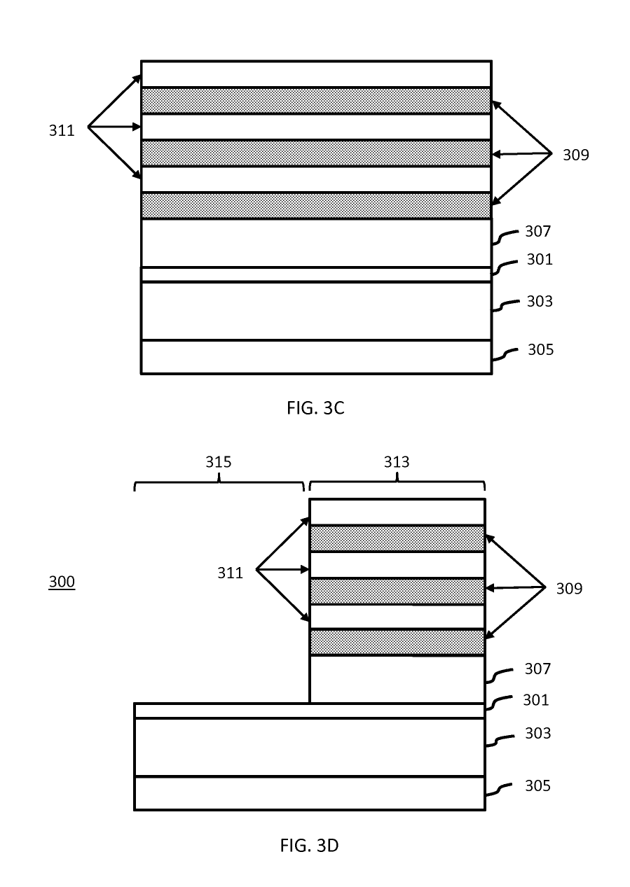

FIGS. 3A through 3D schematically illustrate a process flow for forming a EUV reticle employing a Fabry-Perot thin absorber, in accordance with an exemplary embodiment of the present disclosure.

FIG. 3A illustrates capping layer 301 and reflective multilayer 303 formed over substrate 305. Capping layer 301 may be formed of Ru and may have a thickness from 2 nm to 5 nm. Reflective multilayer 303 may be made of 6.9-7 nm-pitch bilayers of Mo and Si (reflective Mo/Si multilayer). The Mo and Si sub-layers may have a thickness of approximately 2.8 nm and 4.1 nm, respectively. In one embodiment, the first and second sub-layers of reflective multilayer 303 may be formed of lanthanum nitride and boron (LaN/B), respectively, or lanthanum and boron carbide (La/B₄C), respectively. Each of the sub-layers for the LaN/B or La/B₄C stack may have a thickness from 1 nm to 3.4 nm.

Adverting to FIG. 3B, absorber cavity layer 307 is next formed over capping layer 301. Absorber cavity layer 307 may have a thickness from 2 nm to 50 nm and may be formed of, for example, TaN, tantalum boro nitride (TaBN), gold (Au), silver (Ag), platinum (Pt), palladium (Pd), tellurium (Te), carbon (C), nickel (Ni), or Ru.

Adverting to FIG. 3C, one or more resonating layers 309 and a corresponding number of absorber layers 311 are formed interleaved over absorber cavity layer 301. The number of repeats for resonating layer 309 and absorber layer 311 pairs may, for example, be between 2 and 10. Resonating layers 309 may each have a thickness of 2 nm to 3 nm and may be formed of, for example, Si. Absorber layers 311 may each have a thickness of 3 nm to 5 nm and may be formed of, for example, TaN or Ru. The resonating and the absorber layers are formed by low and high absorbing materials, respectively. For example, the resonating layer may be formed by Si, C, Mo, etc. The absorbing layer may be formed by TaN, TaBN, Au, Ag, Pt, Pd, Te, C, Ni, or Ru.

Resonating layers 309 and absorber layers 311 together work as a mirror with respect to the Fabry-Perot cavity formed by absorber cavity layer 307 and capping layer 301. Similarly, reflective multilayer 303 works as another mirror. Absorber layers 311 increase loss associated with radiation from within the cavity, thus decreasing overall reflection of EUV radiation reflected within the cavity.

Finally, as shown in FIG. 3D, resonating layers 309, absorber layers 311, and absorber cavity layer 307 are etched to leave behind a masked non-reflective portion 313 and an unmasked reflective portion 315 of EUV reticle 300.

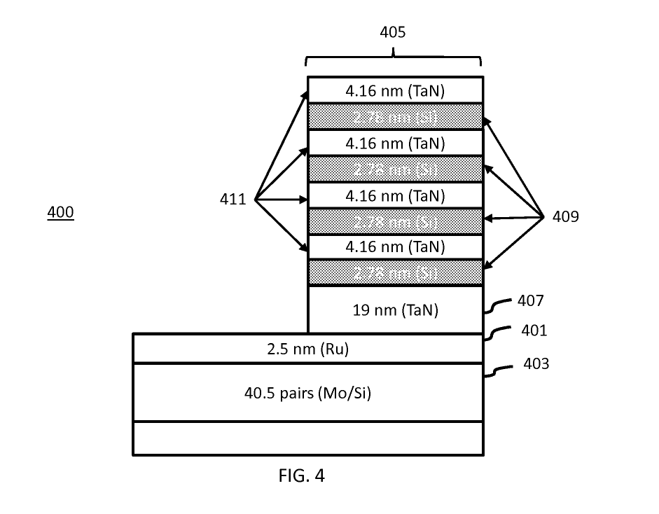

FIG. 4 schematically illustrates a configuration of EUV reticle 400 employing a Fabry-Perot thin absorber, in accordance with an exemplary embodiment of the present disclosure. In this configuration, capping layer 401 is formed of Ru and has a thickness of 2.5 nm, and reflective multilayer 403 is formed of 40.5 pairs of Mo/Si sub-layers. A stack formed in a non-reflective portion 405 of EUV reticle 400 includes absorber cavity layer 407 formed of TaN and has a thickness of 19 nm. Four pairs of resonating layers 409 and absorber layers 411 are formed over absorber cavity layer 407. Each resonating layer 409 is formed of Si and has a thickness of 2.78 nm. Each absorber layer 411 is formed of TaN and has a thickness of 4.16 nm. The combined height of absorber cavity layer 407, resonating layers 409, and absorber layers 411 is 46.75 nm.

In accordance with another exemplary embodiment, absorber cavity layer 407 may be replaced with a Ru capping layer having a thickness of 21 nm, each Si resonating layer 409 may be formed to a thickness of 3.33 nm, and each absorber layer 411 may be replaced with a Ru absorber layer having a thickness of 3.61 nm. A EUV reticle employing a Fabry-Perot absorber using a Ru configuration is easier to fabricate than the EUV reticle of FIG. 4. However, a EUV reticle using a Fabry-Perot absorber with a TaN configuration, as in FIG. 4, demonstrates better performance.

The embodiments of the present disclosure can achieve several technical effects, including improved printability and low defectivity at sub 1×nm technology nodes produced by EUVL. The present disclosure enjoys industrial applicability in any of various EUVL systems used to produce devices for various industrial applications as, for example, microprocessors, smart phones, mobile phones, cellular handsets, set-top boxes, DVD recorders and players, automotive navigation, printers and peripherals, networking and telecom equipment, gaming systems, and digital cameras. The present disclosure therefore enjoys industrial applicability in any of various highly integrated semiconductor devices.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A method comprising:
forming a molybdenum/silicon (Mo/Si) multilayer on an upper surface of a substrate;
forming a ruthenium (Ru) layer over the Mo/Si multilayer;
forming an absorber cavity layer over the Ru layer;
forming two or more pairs of a silicon (Si) layer and an absorbing layer over the absorber cavity layer; and
etching the Si layers, absorbing layers, and the absorber cavity layer to form a stack.

2. The method according to claim 1, comprising forming the stack to a height above the capping layer of 10 nanometer (nm) to 60 nm.

3. The method according to claim 1, comprising:
forming the absorber cavity layer and each absorbing layer of Ru, tantalum boro nitride (TaBN) or tantalum nitride (TaN).

4. The method according to claim 3, comprising:
forming each absorbing layer to a thickness of 3 nm to 5 nm; and
forming each Si layer to a thickness of 2 nm to 3 nm.

5. The method according to claim 3, comprising forming the absorber cavity layer to a thickness of 2 nm to 50 nm.

6. The method according to claim 1, comprising forming the absorber cavity layer and each absorbing layer of tantalum nitride (TaN).

7. The method according to claim 6, comprising:
forming each absorbing layer to a thickness of 3 nm to 5 nm; and
forming each Si layer to a thickness of 2 nm to 3 nm.

8. The method according to claim 6, comprising forming the absorber cavity layer to a thickness of 2 nm to 50 nm.

9. The method according to claim 1, comprising forming the Ru layer to a thickness of 2 nm to 5 nm.

10. A device comprising:
a molybdenum/silicon (Mo/Si) multilayer on an upper surface of a substrate;
a ruthenium (Ru) layer over the Mo/Si multilayer; and
a stack of an absorber cavity layer and two or more pairs of a silicon (Si) layer and an absorbing layer formed on the Ru layer.

11. The device according to claim 10, wherein the stack has a height of 10 nm to 60 nm above the Ru layer.

12. The device according to claim 10, wherein:
the absorber cavity layer and each absorbing layer comprises Ru.

13. The device according to claim 12, wherein:
each absorbing layer is formed to a thickness of 3 nm to 5 nm; and
each Si layer is formed to a thickness of 2 nm to 3 nm.

14. The device according to claim 12, wherein the absorber cavity layer is formed to a thickness of 2 nm to 50 nm.

15. The device according to claim 10, wherein:
the absorber cavity layer and each absorbing layer comprises tantalum nitride (TaN).

16. The device according to claim 15, wherein:
each absorbing layer is formed to a thickness of 3 nm to 5 nm; and
each Si layer is formed to a thickness of 2 nm to 3 nm.

17. The device according to claim 15, wherein the absorber cavity layer is formed to a thickness of 2 nm to 50 nm.

18. The device according to claim 10, wherein the Ru layer is formed to a thickness of 2 nm to 5 nm.

19. A method comprising:
forming a molybdenum/silicon (Mo/Si) multilayer on an upper surface of a substrate;
forming a ruthenium (Ru) layer to a thickness of 2 nm to 5 nm over the Mo/Si multilayer; and
forming a stack having a thickness of 10 nm to 60 nm on the Ru layer by:
forming an absorber cavity layer of Ru or tantalum nitride (TaN) to a thickness of 2 nm to 50 nm over the Ru layer;
forming a silicon (Si) layer over the absorber cavity layer;
forming an absorbing layer of Ru if the absorber cavity layer is formed of Ru or of TaN if the absorber cavity layer is formed of TaN;
forming one to nine additional pairs of a Si layer and an absorbing layer over the absorbing cavity layer; and
etching the Si layers, the absorbing layers, and the absorber cavity layer.

20. The method according to claim 1, comprising:
forming each absorbing layer to a thickness of 3 nm to 5 nm; and
forming each Si layer to a thickness of 2 nm to 3 nm.
